(19) United States
(12) Patent Application Publication
(10) Pub. No.: US 2025/0189635 A1
(43) Pub. Date: Jun. 12, 2025

(54) LIGHT SOURCE MODULE INCLUDING AN OPTICAL PATH AND A METHOD OF OPERATING THE LIGHT SOURCE MODULE

(71) Applicant: Namuga Co., Ltd., Seongnam-si (KR)

(72) Inventors: Jun Youb LEE, Seongnam-si (KR); Young Gyu KANG, Yongin-si (KR); Dong Ho LEE, Seongnam-si (KR)

(73) Assignee: Namuga Co., Ltd., Seongnam-si (KR)

(21) Appl. No.: 18/962,062

(22) Filed: Nov. 27, 2024

(30) Foreign Application Priority Data
Dec. 11, 2023 (KR) 10-2023-0178209
Aug. 23, 2024 (KR) 10-2024-0113305

(51) Int. Cl. G01S 7/481; G01S 7/4865

(52) U.S. Cl. CPC G01S 7/4813; G01S 7/4816; G01S 7/4865

(57) ABSTRACT

A light source module has a holder for fixing a light transmitter and a light receiver onto a substrate, the light transmitter having a light source placed on one side of the substrate and emitting light for measuring a depth distance, and a diverging lens assembly emitting light directed from the light source toward a target object; and the light receiver having a converging lens assembly for receiving light reflected from the target object, and a sensor unit comprising a single pixel or multiple pixels for detecting the light. The module has a connection unit that includes a light shielding structure blocking noise light directly coming from the light source to the light receiver, an optical path between the light shielding structure and the light transmitter to recognizes a timing of the light emitted from the light source, and an optical path space structure is located below the optical path.

### CROSS REFERENCE TO RELATED APPLICATION

This application claims the benefit of and priority to Korea Patent Application No. 10-2023-0178209, filed on Dec. 11, 2023, and Korea Patent Application No. 10-2023-0178209, filed on Aug. 23, 2024, which are hereby incorporated by reference for all purposes as if fully set forth herein.

### FIELD OF TECHNOLOGY

The present disclosure relates to a light source module including an optical path and a method for operating the light source module, and more specifically, to a light source module including an optical path for recognizing a timing when light is emitted and a method for operating the light source module.

### BACKGROUND

Stereo vision, structured light, and time-of-flight (TOF) methods are representative methods used to determine a three-dimensional distance or depth information of a target object. These methods use different principles and devices to obtain three-dimensional information and play an important role in various applications.

Among these methods, the TOF method is a method that measures a distance by repeatedly generating a laser with a predetermined pulse and calculating an arrival time of a pulse reflected from a target object. Like the structured light method, the TOF method requires a projector to project beams onto the object. There is a direct measurement method that calculates a time taken for a pulse transmitted from a light transmitter to reflect off of a target object and return back to a light receiver, as well as an indirect measurement method that calculates a phase difference of the received pulse. However, the indirect measurement method is more widely used.

Among the aforementioned methods for obtaining 3D information, the structured light method and the TOF method, unlike the stereo vision method, further involve the process of scanning a beam from a light transmitter onto a target object, which means a light source is included in the configuration. In addition, an optical device is used to emit a beam at a predetermined angle so that light from the light source can reach the object appropriately. Lenses, diffusers, prisms, beam splitters, etc. are widely used as optical devices, and such various optical devices may be used to appropriately adjust an angle and direction of the beam.

Meanwhile, the TOF method generally sends a trigger signal, which is an electrical signal, directly from the light transmitter to the light receiver to detect a timing when a pulse is emitted from the light source. Synchronization using such a trigger signal is very important in the TOF method, and if accurate synchronization is not achieved, errors in round-trip time measurement may occur, which will significantly affect the accuracy of distance measurement.

However, according to conventional methods, a time delay occurs during synchronization using a trigger signal, making accurate synchronization difficult and reducing the accuracy of distance measurement. Therefore, precise synchronization technology is required to determine a timing when a pulse is emitted.

The discussions in this section are intended merely to provide background information and do not constitute an admission of prior art.

### SUMMARY

In view of the above, the present disclosure provides a light source module that implements precise synchronization using an optical path for recognizing a timing when light is emitted from a light source.

The present disclosure also provides a light source module including an optical path of various shapes to control a pulse emitted from a light source.

The present disclosure also provides a method for operating a synchronized light source module using an optical path.

In one aspect, a light source module is provided, including: a light transmitter including a light source arranged on one side of a substrate and emitting light for measuring a depth distance; and a diverging lens assembly emitting light transmitted from the light source toward a target object; a light receiver including a light receiver lens assembly for receiving the light reflected from the target object; a sensor unit including a single or multiple pixels capable of detecting light; a holder for fixing the light transmitter and the light receiver on the substrate; a light shielding structure for blocking noise light directly transmitted from the light source of the light transmitter to the light receiver; and a connection unit including an optical path provided between the light shielding structure and the light transmitter unit for recognizing a time point at which light is emitted from the light source.

The diverging lens assembly may include a first diverging lens for collecting the light directed from the light source and a second diverging lens for emitting the collected light toward the target object.

The holder may fix the first diverging lens and the second diverging lens onto the substrate.

The light receiver may further include a filter that allows only a wavelength of light detectable by the sensor unit to pass therethrough.

The sensor unit may include a first sensor capable of detecting the light reflected from the target object and a second sensor capable of detecting the light directed from the optical path.

The first sensor may be positioned on a side of the light receiver unit with respect to the light shielding structure, and the second sensor may be positioned on a side of the light transmitter with respect to the light shielding structure.

The light shielding structure may be placed on the sensor unit and has a shape protruding from the sensor unit, and a height of one end of the light shielding structure may be higher than a height of one end of the light source.

The light shielding structure may be placed at a predetermined distance from the light source.

By being placed between the sensor unit and the holder to form a hermetically sealed connection, the light shielding structure may block light directly coming from the light transmitter.

The optical path may be formed by penetrating a part of the optical path space structure.

The optical path may be formed by penetrating a part of a lower side of the holder.

The optical path may further include a composition capable of controlling a light transmittance or light absorption rate.

The optical path may include a plurality of protrusions extending inward within a path through which light travels, allowing for control over an amount of light.

The plurality of protrusions may vary in at least one of shape, spacing, and height, and each of the plurality of protrusions may include a coating layer formed in a surface thereof, which controls a light transmittance or light absorption rate.

In another aspect, a method for operating a light source module is provided, the method including: a light emitting operation in which a light source emits light for measuring a depth distance from a light source and a diverging lens assembly emits light toward a target object; a light receiving operation in which a converging lens assembly receives the light reflected from the target object and a sensor unit detects the light; and a light emission recognizing operation in which a part of the light emitted from the light source is directed to one side of the sensor unit through an optical path to recognize a timing when light is emitted from the light source. The light emitting operation and the light emission recognizing operation are performed simultaneously.

The sensor unit may include a first sensor capable of detecting the light reflected from the target object and a second sensor capable of detecting the light directed from the optical path.

The optical path may be formed by penetrating a part of the optical path space structure.

The optical path may be formed by penetrating a part of a lower side of the holder.

The above optical path may further include a composition capable of controlling a light transmittance or light absorption rate.

The optical path may include a plurality of protrusions extending inward within a path through which light travels, allowing for control over an amount of light, the plurality of protrusions may vary in at least one of shape, spacing, and height, and each of the plurality of protrusions may include a coating layer formed in a surface thereof, which control a light transmittance or light absorption rate.

As described above, according to the present disclosure, a light source module that implements precise synchronization using an optical path for recognizing a timing when light is emitted from a light source may be provided.

In addition, according to the present disclosure, a light source module including an optical path of various shapes to control a pulse emitted from a light source may be provided.

Furthermore, according to the present disclosure, a method for operating a synchronized light source module using an optical path may be provided.

The technical problems to be achieved in this document are not limited to the technical problems mentioned above, and other technical problems not mentioned will be clearly understood by those skilled in the art to which the present disclosure belongs from the description below.

### BRIEF DESCRIPTION OF THE DRAWINGS

In order that the disclosure may be well understood, there are now described various forms thereof, given by way of example, reference being made to the accompanying drawings, in which:

FIG. 1 is a diagram illustrating the configuration of a light source module according to one embodiment.

FIG. 2 is a schematic diagram showing a light transmitter according to one embodiment.

FIG. 3 is a schematic diagram showing a light receiver according to one embodiment.

FIG. 4 is a schematic diagram showing a light source module according to one embodiment.

FIG. 5 is a schematic diagram showing a process of operating a light source module according to one embodiment.

FIGS. 6 and 7 are schematic diagrams showing a sensor unit according to one embodiment.

FIG. 8 is a first exemplary view showing an optical path according to one embodiment, and FIG. 9 is an enlarged view of the first exemplary view.

FIG. 10 is a second exemplary view showing an optical path according to one embodiment, and FIG. 11 is an enlarged view of the second exemplary view.

FIG. 12 is a third exemplary view showing an optical path according to one embodiment, and FIG. 13 is an enlarged view of the third exemplary view.

FIG. 14 is a fourth exemplary view showing an optical path according to one embodiment, and FIG. 15 is an enlarged view of the fourth exemplary view.

FIG. 16 is a flowchart illustrating a method for operating a light source module according to one embodiment.

### DETAILED DESCRIPTION

Hereafter, some embodiments of the present disclosure are described in detail with reference to the accompanying drawings. With regard to the reference numerals of the components of the respective drawings, it should be noted that the same reference numerals are assigned to the same components even when the components are shown in different drawings. In addition, in describing the present disclosure, detailed descriptions of well-known configurations or functions have been omitted in order to avoid obscuring the gist of the present disclosure.

In addition, terms such as “1st”, “2nd”, “A”, “B”, “(a)”, “(b)”, or the like may be used in describing the components of the present disclosure. These terms are intended only for distinguishing a corresponding component from other components, and the nature, order, or sequence of the corresponding component is not limited to the terms. In the case where a component is described as being “coupled”, “combined”, or “connected” to another component, it should be understood that the corresponding component may be directly coupled or connected to another component or that the corresponding component may also be “coupled”, “combined”, or “connected” to the component via another component provided therebetween.

A light source module according to one embodiment may include: a light transmitter comprising a light source placed on one side of a substrate and emitting light for measuring a depth distance, and a diverging lens assembly emitting light directed from the light source toward a target object; a light receiver comprising a converging lens assembly for receiving light reflected from the target object, and a sensor unit comprising a single pixel or multiple pixels for detecting the light; a holder for fixing the light transmitter and the light receiver onto the substrate; and a connection unit comprising a light shielding structure for blocking noise light directly coming from the light source of the light transmitter to the light receiver, an optical path provided between the light shielding structure and the light transmitter to recognize a timing when the light is emitted from the light source, and an optical path space structure located below the optical path.

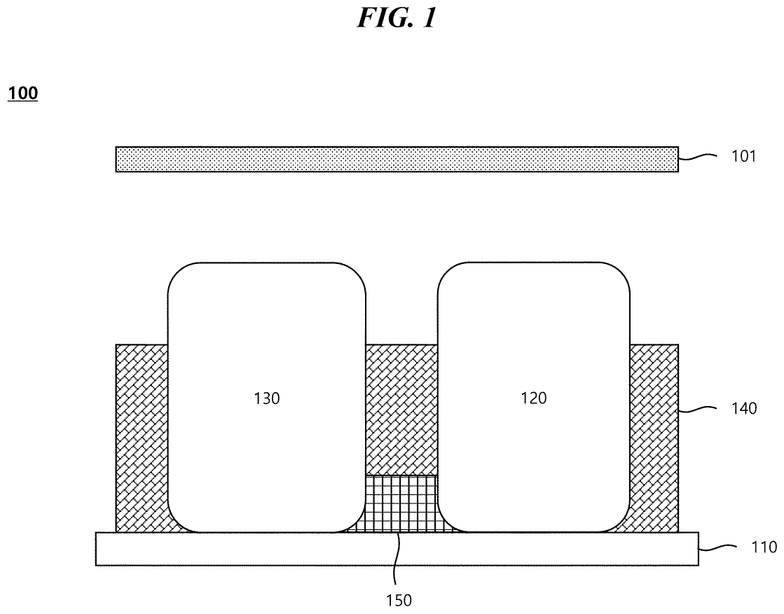

FIG. 1 is a diagram illustrating the configuration of a light source module according to one embodiment.

Referring to FIG. 1, a light source module 100 according to one embodiment may include a substrate 110, a light transmitter 120, a light receiver 130, a holder 140, and a connection unit 150.

The light transmitter 120 and the light receiver 130 may be placed on the substrate 110, and the light transmitter 120 and the light receiver 130 may be fixed onto the substrate 110 by the holder 140. The light transmitter 120 and the light receiver 130 may be connected by the connection unit 150 to interact with each other.

The light transmitter 120 may repeatedly generate a laser light with a predetermined pulse and output the light toward a target object 101, and the light receiver 130 may receive the light reflected from the target object 101. In doing so, it is possible to measure a distance to the target object 101 by calculating an arrival time of the light reflected from the target object 101.

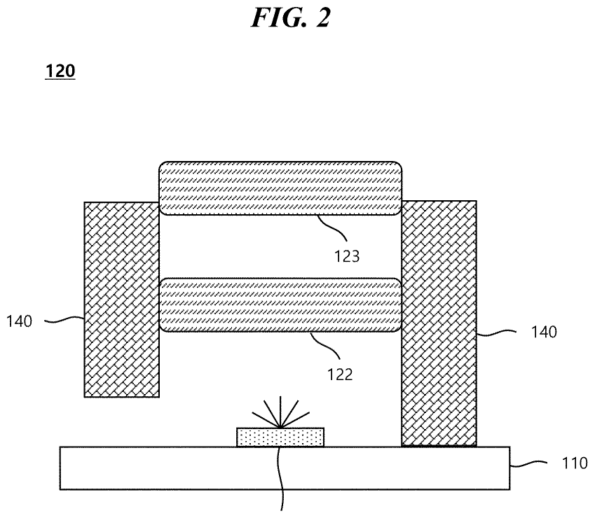

FIG. 2 is a schematic diagram showing a light transmitter according to one embodiment.

Referring to FIG. 2, a light transmitter 120 according to one embodiment may include a light source 121, a first diverging lens 122, and a second diverging lens 123.

The light source 121 may be placed on a substrate 110 and may repeatedly output a laser light with a constant pulse. An anode electrode of the light source 121 may be connected to an anode wiring of the substrate 110, and a cathode electrode of the light source 121 may be connected to a cathode wiring of the substrate 110. This connection allows the light source 121 to receive stable power and operate efficiently.

The light source 121 may be connected to the substrate 110 in various methods. One of the most common methods is to connect and arrange the light source 121 by wire bonding. The wire bonding is a method of directly connecting an electrode of the light source 121 to a corresponding pad of the substrate 110 with a metal wire.

Another method is flip chip bonding, which is a method of placing the light source 121 directly on the substrate 110 without wires. In this case, the electrode of the light source 121 comes into direct contact with the corresponding pad on the substrate 110, providing higher integration and strength compared to wire bonding. The light source 121 connected by flip chip bonding does not require wires, thereby enhancing the miniaturization and reliability of the device. Therefore, flip-chip bonding is advantageous in constructing a high-performance and miniaturized distance-measuring device.

The light source 121 may be any light source capable of outputting light, such as a laser. In particular, vertical-cavity surface-emitting lasers (VCSELs) and light-emitting diodes (LEDs) are widely used.

In particular, a VCSEL is a type of semiconductor laser with a structure that emits light vertically. This differs from the existing edge-emitting lasers, and has a structure in which an active layer is located between two reflective mirrors (Bragg reflectors). This structure is composed of a very thin layer, and light is emitted in a vertical direction.

The VCSEL produces light in the active layer as electrons and holes combine when current flows through the p-n junction of the VCSEL. This light is reflected multiple times between the two reflecting mirrors, forming a resonance, and then amplified at a specific wavelength and emitted through the surface. The VCSELs offer high-speed response, low power consumption, and high efficiency, and are easily expandable into an array form. The VCSEL provides high-speed response and high output efficiency, which ensures suitability for Time of Flight (TOF) distance measurement systems.

Meanwhile, LEDs may provide a variety of wavelengths and colors, expanding the range of light sources.

The substrate 110 supports the light source 121 and provides a foundation structure on which the light source 121 can be stably placed. The substrate 110 may be patterned with wiring for electrical connection, which is essential for supplying power to electronic components such as the light source 121. The substrate 110 receives power from an external power source and directs the power to the light source 121 through each wire. In doing so, the light source 121 may be continuously supplied with power and maintain stable operation.

The substrate 110 may be formed of various materials. In addition to traditional silicon substrates, high-performance ceramic substrates or flexible polymer substrates may be used. These substrates provide properties such as high temperature stability, electrical insulation, and mechanical strength, which contribute to improving the performance and reliability of the light source 121 and related electronic components.

Light from the light source 121 may be directed through the diverging lens assembly toward the target object 101. The diverging lens assembly may include a first diverging lens 122 and a second diverging lens 123.

The first diverging lens 122 may collect light from the light source 121 and direct the light to the second diverging lens 123. Specifically, the first diverging lens 122 may serve to parallelize the light. This prevents the light from spreading widely in a specific direction and allows aiming parallel to a predetermined direction. The first diverging lens 122 may be composed of a convex lens or a composite optical system. Meanwhile, when the diverging light emitted from the light source 121 passes through the first diverging lens 122, the first diverging lens 122 may adjust the light to be parallel, thereby directing the light from a point light source in a parallel manner to a relatively long distance. This minimizes the spread of light and maintains the directionality of light, providing high precision and efficiency. For example, the first diverging lens 122 may include a collimator lens (CL), etc.

The second diverging lens 123 may utilize diffraction of light to form a specific pattern or beam. In particular, the second diverging lens 123 may perform various functions by manipulating the phase, amplitude, wavelength, etc. of light.

Specifically, the second diverging lens 123 may have a surface patterned with a microscopic structure, thereby enabling the diffraction of light in a particular way as light passes through. This structure may typically be fabricated using techniques such as photolithography, nanoimprint lithography, and others.

When light passes through the surface pattern of the second diverging lens 123, the phase or amplitude of the light is changed to generate a desired diffraction pattern. For example, the second diverging lens 123 may split light into multiple light spots or form a specific image. Thus, the second diverging lens 123 may be capable of very precise beam shaping and manipulation and may perform more complex optical functions than traditional lenses and mirrors. For example, the second diverging lens 123 may include a diffuser, a diffractive optical element (DOE), a micro lens array (MLA), a Fresnel lens, and the like, and may include a lens or a prism capable of changing an optical path or an angle of radiation of light.

The first diverging lens 122 and the second diverging lens 123 may be fixed onto the substrate 110 using the holder 140. At this point, the light source 121, the first diverging lens 122, and the second diverging lens 123 may be assembled to match each focal length, and may be fixed onto the substrate 110 using the holder 140 with the focal length set.

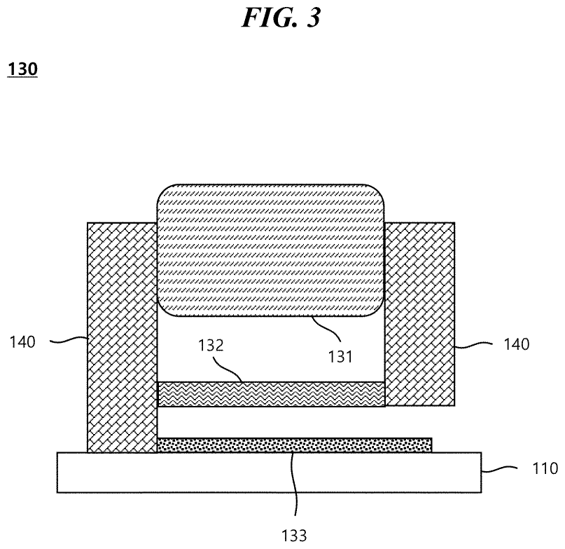

FIG. 3 is a schematic diagram showing a light receiver according to one embodiment.

Referring to FIG. 3, a light receiver 130 may include a converging lens assembly 131, a filter 132, and a sensor unit 133.

The converging lens assembly 131 may receive light directed from a light source 121 and reflected from a target object 101 and direct the light to the sensor unit 133. The converging lens assembly 131 may collect light that is reflected and spread by the target object 101 to effectively deliver the light to the sensor unit 133.

Specifically, the converging lens assembly 131 may be a composite optical system composed of one or more lenses. This converging lens assembly 131 may utilize a convex lens to collect reflected light and may serve to focus the collected light. The converging lens assembly 131 refracts the reflected light passing through and directs the light onto a focal plane where the sensor unit 133 is located. This allows more reflected light to be directed to the sensor unit 133, thereby improving a signal-to-noise ratio (SNR) and increasing measurement accuracy. Using the converging lens assembly 131, light collection efficiency may be enhanced, and the resolution of the optical system may be improved.

The filter 132 may serve to allow only light at a specific wavelength to pass therethrough and block other wavelengths. This is to reduce the influence of unnecessary external light sources and increase the accuracy of measurement.

Specifically, the filter 132 may be composed of a broadband filter or a narrowband filter, which are optical devices designed to selectively allow only light at a specific wavelength to pass therethrough.

Light emitted from the light source 121 has a specific wavelength, and when reflected light passes through the filter 132, the filter 132 allows only light at the specific wavelength to pass therethrough and blocks light at other wavelengths. For example, when using infrared light with a wavelength of 850 nm, the filter 132 allows only light at the wavelength of 850 nm to pass therethrough and blocks light at other wavelengths (e.g., visible light). This may reduce unnecessary light interference occurring in the surrounding environment, thereby increasing the purity of a signal transmitted to the sensor unit 133 and improving the accuracy and reliability of measurement.

The sensor unit 133 detects reflected light and converts the detected light into an electrical signal. The sensor unit 133 is one of the core components of a light source module 100 and may analyze and process received light data.

Specifically, when the reflected light reaches the sensor unit 133, one or more pixels included in the sensor unit 133 detect the light and convert the detected light into an electrical signal. In the case of a TOF system, the sensor unit 133 may calculate distance information by very accurately measuring a time when light arrives.

The sensor unit 133 provides very high sensitivity and fast response time. This may enable high-accuracy 3D distance measurement and image processing.

The sensor unit 133 may be an image sensor, for example, a photodiode (PD), a charge-coupled device (CCD), a complementary metal-oxide semiconductor (CMOS), etc. In addition, an optical sensor 80 may be a device capable of sensing light, such as a photodetector (PD).

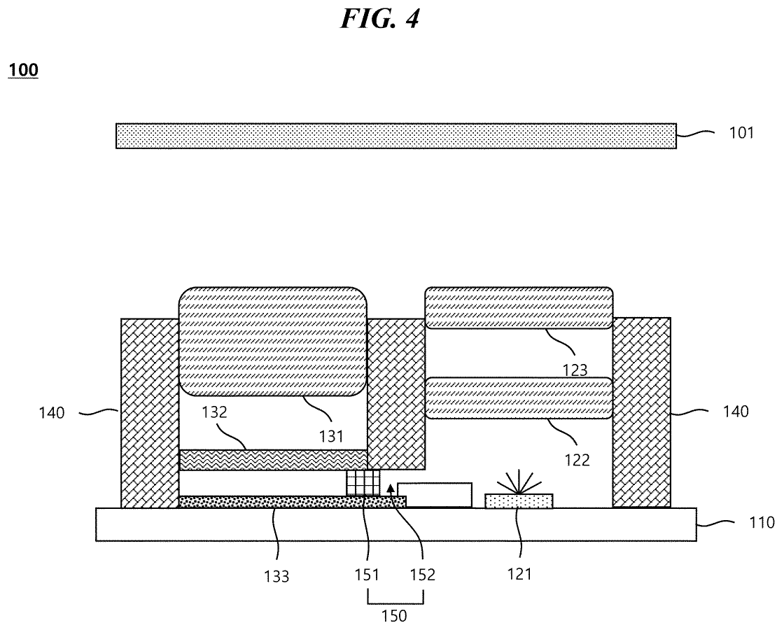

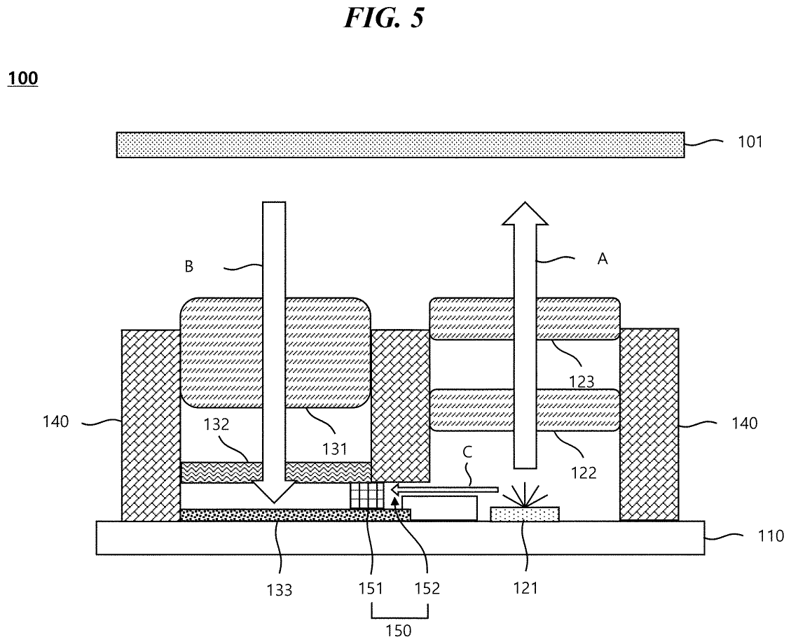

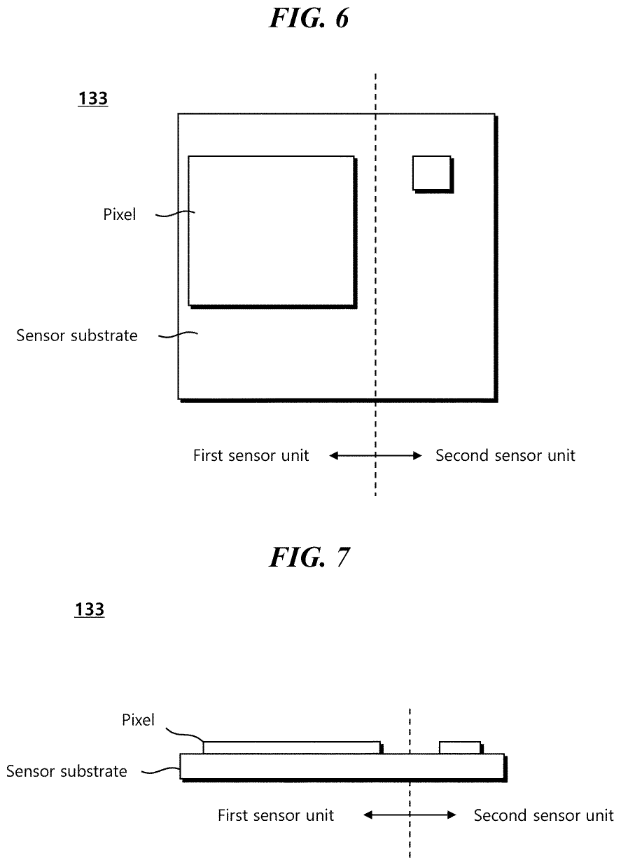

FIG. 4 is a schematic diagram showing a light source module according to one embodiment, FIG. 5 is a schematic diagram showing a process of operating a light source module according to one embodiment, and FIG. 6 is a schematic diagram showing a sensor unit according to one embodiment.

Referring to FIGS. 4 to 7, a light transmitter 120 may include a light source 121 that is placed on one side of a substrate 110 to emit light; a first diverging lens 122 that collects light directed from the light source 121 and directs the collected light to a second diverging lens 123; and the second diverging lens 123 that directs light toward the target 101.

The light receiver 130 may include a converging lens assembly 131 that receives light reflected from a target object 101 and directs the received light to a sensor unit 133; a filter 132 that allows only light at a specific wavelength to pass therethrough; and a sensor unit 133 that detects the reflected light and converts the detected light into an electrical signal.

A diverging lens assembly 122, 123 and the light receiver lens assembly 131 may be all or part of a cover (not shown) supported by a holder 140. That is, all areas supported by the holder 140 may be defined as the diverging lens assembly 122, 123 and the converging lens assembly 131; however, the diverging lens assembly 122, 123 and the converging lens assembly 131 may be arranged or formed only in an area corresponding to the light source 121 and an area corresponding to a part of the sensor unit 133.

As long as the diverging lens assembly 122, 123 is supported by the holder 140, the diverging lens assembly 122, 123 and the converging lens assembly 131 may be either separate from or integral with the holder 140, and the positions, structures, and shapes of the diverging lens assembly 122, 123 and the converging lens assembly 131 may vary depending on the shape of the holder 140.

The holder 140 may be placed on the substrate 110 and may support the diverging lens assembly 122, 123 and the converging lens assembly 131 while spacing the diverging lens assembly 122, 123 and the converging lens assembly 131 apart from a light source 121 by a predetermined distance. In addition, the holder 140 may separate the internal and external spaces of the light source module 100 from each other and protect the internal components of the light source module 100 from changes in the external environment.

A connection unit 150 may include: a light shielding structure 151 that blocks noise light directly coming from the light source 121 of the light transmitter 120 to the light receiver 130; an optical path 152 positioned between the light shielding structure 151 and the light transmitter 120 to recognize a time when light is emitted from the light source 121.

Here, the noise light may result from light measured inside or outside the light source module, or light from sources other than the target object 101 intended to be measured by the sensor unit 133.

The light shielding structure 151 may be placed between the light source 121 and the light receiver 130 to block light emitted from the light source 121 from reaching the sensor unit 133.

The light shielding structure 151 may be a structure that physically blocks light, but is not limited thereto and may include any structure or material that functions to block light optically. Here, if the light shielding structure 151 refers to a structure that reduces or blocks the intensity of light, the light shielding structure 151 may be defined as an optical cover, an optical frame, etc., and may be a part of the holder 140, or a separate, distinct structure.

In addition, the light shielding structure 151 may be positioned above the sensor unit 133 and may include an elastic material to act as a buffer to prevent damage to the sensor unit. This elastic material has compressibility, providing a cushioning effect that prevents damage to the sensor unit 133 while offering a shielding function through hermetic bonding.

Furthermore, by maintaining a predetermined distance from structures above the sensor unit 133 and absorbing internal and external shocks, the light shielding structure 151 may serve to buffer external forces applied to the sensor unit 133.

Meanwhile, the light shielding structure 151 may be positioned as a single structure integrally connected to an optical path space structure 153 or may be positioned separately as a distinct structure.

The light shielding structure 151 may be placed at any location within the distance between one end of the light source 121 and one end of the sensor unit 133.

In addition, the light shielding structure 151 may be designed to correspond to the length between the substrate 110 and the converging lens assembly 131 and serve to spatially separate the light transmitter 120 and the light receiver 130 of the light source module 100. In this case, the light shielding structure 151 may form two sealed spaces to prevent light from passing through, thereby improving noise caused by leaked or reflected light reaching the sensor unit 133.

In addition, the light shielding structure 151 may be a structure extending from the holder 140 and connected to the holder 140.

The sensor unit 133 may include one or more pixels for detecting light, a first sensor capable of detecting light reflected from a target object, and a second sensor capable of detecting light directed from the optical path 152.

Here, the first sensor may be placed on the side of the light receiver 130 with respect to the light shielding structure 151, and the second sensor may be placed on the side of the light transmitter 120 with respect to the light shielding structure 151.

When multiple pixels are used, a pixel located in the first sensor and a pixel located in the second sensor may be arranged separately.

When a single pixel is used, the single pixel may function as both the first sensor and the second sensor. That is, both the light reflected from a target object and entering the first sensor through one pixel, and the light directed from the optical path 152 and entering the second sensor may be detected.

The sensor unit 133 may further include a light transmissive layer on the surface. The light transmissive layer may be a distinct structure separated from the sensor unit 133 or may be a structure conceptually distinct from the sensor unit 133.

The light transmissive layer may be an optical device in the form of glass, but is not limited thereto and may be any device capable of transmitting light. For example, the light transmissive layer may be a cover glass attached to the surface of the sensor unit 133.

Since the light transmissive layer positioned at the top of the sensor unit 133 has a constant thickness, the internal reflected light of the light source module 100 enters from a side other than an optical axis.

In the case of the sensor unit 133 having a light transmissive layer, even if the light-shielding structure 151 is formed on the top of the sensor unit 133, the sensor unit 133 may be affected by light directed from the side of the sensor unit 133. Light incident from the side may reach an effective light sensing area of the sensor unit 133 through the optical path inside the light transmissive layer.

Meanwhile, the light shielding structure 151 may be placed on the sensor unit 133 and may have a shape protruding from the sensor unit 133. In addition, a height of one end of the light shielding structure 151 may be higher than a height of one end of the light source 121.

In addition, by being positioned at a predetermined distance from the light source 121, the light shielding structure 151 may effectively block noise light from reaching the light receiver 130.

Furthermore, by being placed between the sensor unit 133 and the holder 140 to form a hermetically sealed connection, the light shielding structure 151 may block light directly coming from the light transmitter 120.

Meanwhile, distance measurement is generally performed by synchronization using a trigger signal in Time of Flight (TOF) method. However, the accuracy of distance measurement may be adversely affected by a time delay that may occur during synchronization via a trigger signal.

In the TOF method, a distance is calculated by measuring a time difference between when a light source is emitted and when reflected light is received. If a trigger signal is not precisely synchronized between the light transmitter and light receiver, or if there is a delay in the trigger signal itself, an error occurs in the measured time difference. This may lead to incorrect distance calculation and may be critical, especially in applications requiring high-precision measurement.

Furthermore, the time delay of the trigger signal may make it difficult to track the motion of a moving object, lead to inconsistent data that results in distorted images, and, if the reflective surface characteristics of the target object 101 change, may prevent an effective response to the changes due to the delay of the trigger signal.

Therefore, the light source module according to one embodiment may include the optical path 152 to directly recognize a timing when light is emitted from the light source 121.

The optical path 152 may be provided between the light shielding structure 151 and the light transmitter 120 to form a light travel path through which light may travel from a light source 121 to a second sensor of the sensor unit 133.

Specifically, referring to the operation process of the light source module 100 of FIG. 5, light A is transmitted from the light source 121 placed on one side of the substrate 110, and the light A may pass through the first diverging lens 122 and the second diverging lens 123 and be directed toward the target object 101.

The light receiver 130 may receive light B reflected from the target object 101 and transmit the light B to the sensor unit 133 through the light receiver lens assembly 131 and the filter 132. Specifically, the light B may be directed to the first sensor of the sensor unit 133.

Meanwhile, some of the light C generated from the light source 121 may be directed to the second sensor through the optical path 152 to recognize a timing when light is emitted from the light source 121. This ensures accurate synchronization without any time delay.

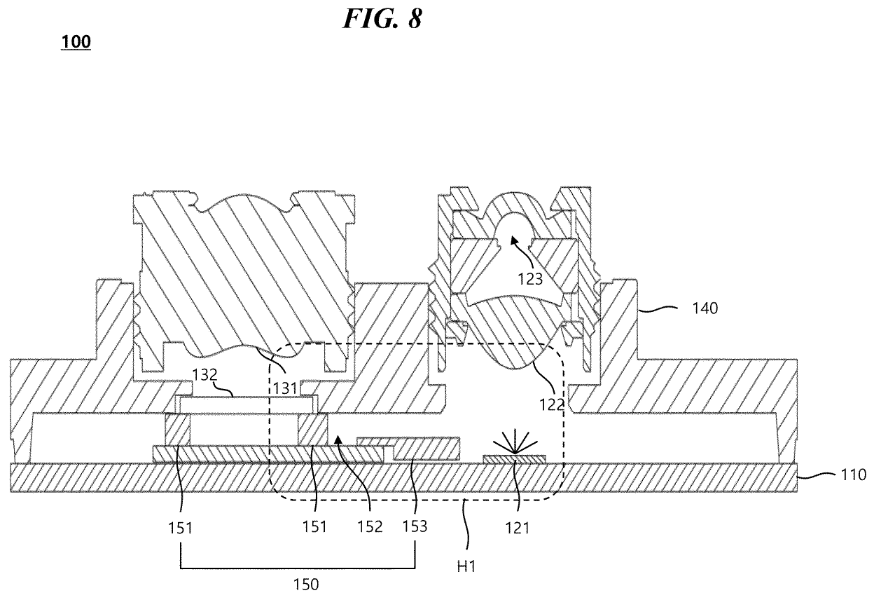

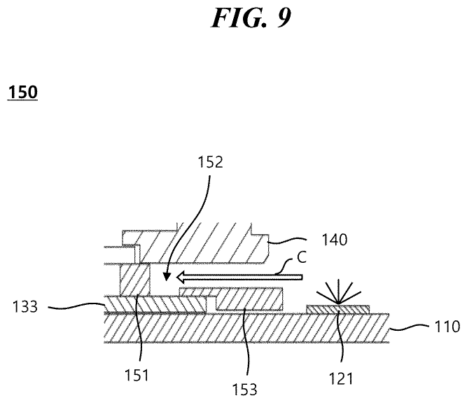

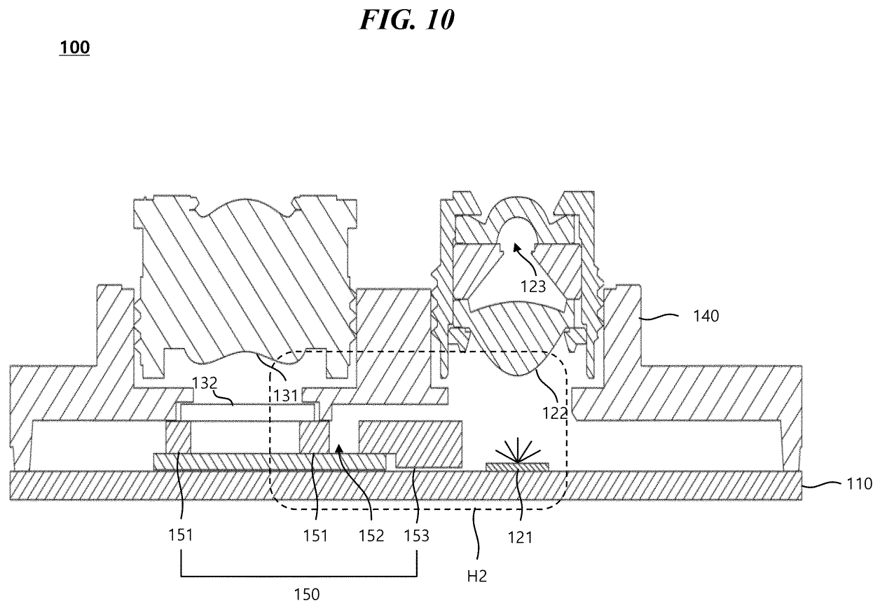

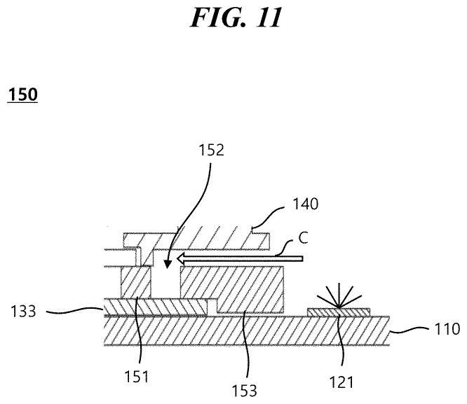

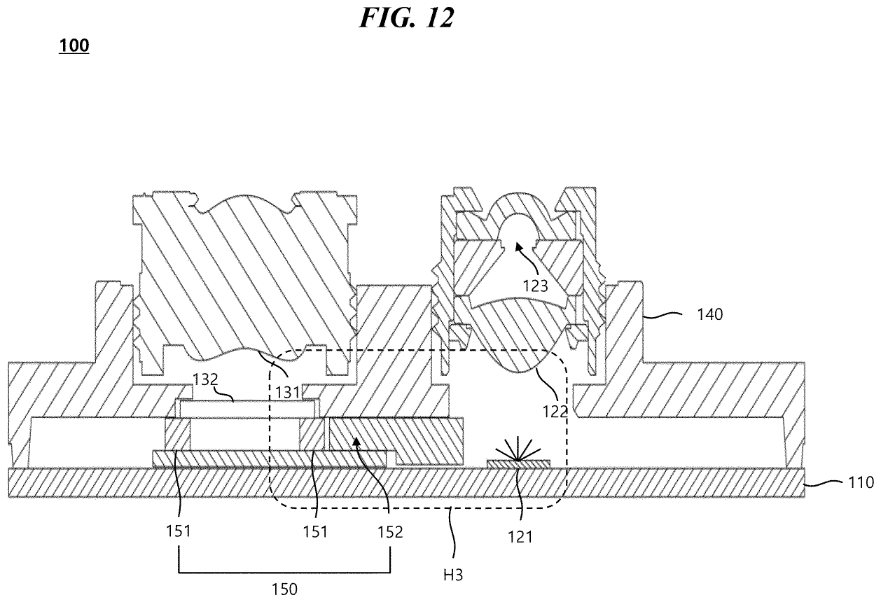

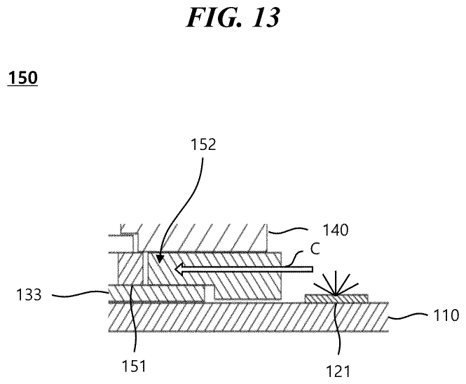

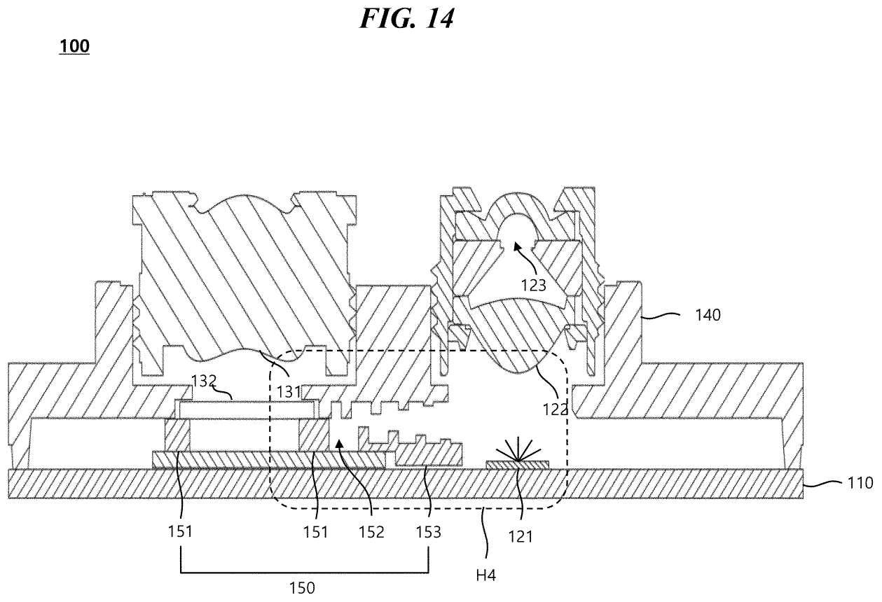

FIG. 8 is a first exemplary view showing an optical path according to one embodiment, FIG. 9 is an enlarged view of the first exemplary view, FIG. 10 is a second exemplary view showing an optical path according to one embodiment, FIG. 11 is an enlarged view of the second exemplary view, FIG. 12 is a third exemplary view showing an optical path according to one embodiment, FIG. 13 is an enlarged view of the third exemplary view, FIG. 14 is a fourth exemplary view showing an optical path according to one embodiment, and FIG. 15 is an enlarged view of the fourth exemplary view.

Referring to FIGS. 8 to 15, various shapes of an optical path 152 for recognizing and synchronizing a timing when light is emitted may be observed.

Specifically, referring to FIGS. 8 and 9, the optical path 152 may be formed by penetrating a part of the optical path space structure 153. Therefore, the shape of the holder 140 may be maintained, and a part of the optical path space structure 153 may be penetrated to establish a connection with the light transmitter 120, thereby forming the optical path 152. In this case, light C generated from a light source 121 may pass through the optical path 152 formed at a location relatively close to a substrate 110 and move to the second sensor of the sensor unit 133.

Referring to FIGS. 10 and 11, the optical path 152 may be formed by penetrating a part of a lower side of the holder 140. Accordingly, the shape of the light shielding structure 151 may be maintained, and a part of the lower side of the holder 140 close to the substrate 110 may be penetrated to form the optical path 152. In this case, the light C generated from the light source 121 may pass through the optical path 152 formed at a relatively distant location from the substrate 110 and move to the second sensor of the sensor unit 133.

In this way, by adjusting a height at which the optical path 152 is formed, the amount of light C generated from the light source 121 may be controlled, thereby achieving more accurate synchronization.

Next, referring to FIGS. 12 and 13, the optical path 152 may further include a composition capable of controlling a light transmittance or light absorption rate. Therefore, the shapes of both the light shielding structure 151 and the holder 140 may be maintained. In this case, the amount of light C generated from the light source 121 may be controlled by the composition that fills the optical path 152.

Meanwhile, the composition included in the optical path 152 may be any material capable of controlling at least one of the light transmittance rate and light absorption rate of light C generated from the light source 121.

In addition, referring to FIGS. 14 and 15, the optical path 152 may include a plurality of protrusions extending inward within a path through which light travels. In this case, the plurality of protrusions formed inside the optical path 152 may vary in at least one of shape, spacing, and height to control an amount of light. In addition, each of the plurality of protrusions may include a coating layer formed in a surface thereof, which controls a light transmittance or light absorption rate.

Specifically, when the amount of light C generated by the light source 121 is large, the spacing between protrusions inside the optical path 152 may become narrower and the height may be increased, allowing for greater internal diffuse reflection of light C passing through the optical path 152. Conversely, when the amount of light C generated by the light source 121 is low, the spacing between protrusions inside the optical path 152 may become wider and the height may be reduced, allowing for less internal diffuse reflection of light C passing through the optical path 152.

Furthermore, a coating layer may be formed by additionally applying a coating agent capable of controlling a light transmittance or light absorption rate to the surface of each of the plurality of protrusions. The coating layer may further control the amount of light C passing through the light passage portion 152, etc.

As such, more accurate synchronization may be achieved by adjusting the internal composition or geometry of the optical path 152 to control the amount of light C generated by the light source 121.

Next, a method for operating a light source module according to another embodiment is specifically described.

A method for operating a light source module according to one embodiment may include: a light emitting operation in which a light source emits light for measuring a depth distance from a light source and a diverging lens assembly emits light toward a target object; a light receiving operation in which a converging lens assembly receives the light reflected from the target object and a sensor unit detects the light; and a light emission recognizing operation in which a part of the light emitted from the light source is directed to one side of the sensor unit through an optical path to recognize a timing when light is emitted from the light source. The light emitting operation and the light emission recognizing operation may be performed simultaneously.

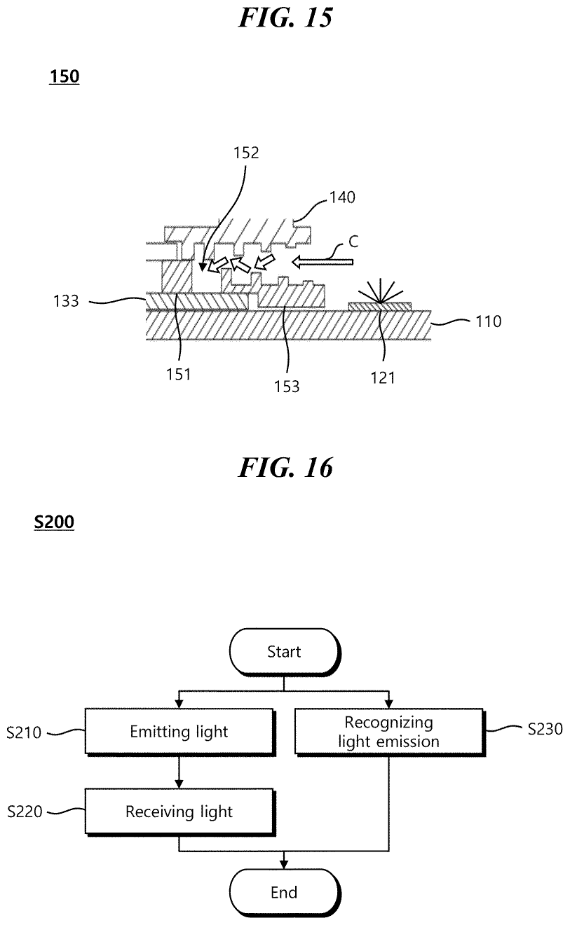

FIG. 16 is a flowchart illustrating a method for operating a light source module according to one embodiment.

Referring to FIG. 16, a method S200 for operating a light source module may include a light emitting operation S210 and a light receiving operation S220, and may further include a light emission recognizing operation S230. The light emitting operation S210 and the light emission recognizing operation S230 may be performed simultaneously.

In the light emitting operation S210, a light source 121 may emit light to measure a depth distance of a target object 101, and a diverging lens assembly may emit light toward the target object 101.

The light source 121 may be placed on a substrate 110 and may repeatedly output a laser light with a constant pulse. An anode electrode of the light source 121 may be connected to an anode wiring of the substrate 110, and a cathode electrode of the light source 121 may be connected to a cathode wiring of the substrate 110. This connection allows the light source 121 to receive stable power and operate efficiently.

The light source 121 may be any light source capable of outputting light, such as a laser. In particular, vertical-cavity surface-emitting lasers (VCSELs) and light-emitting diodes (LEDs) are widely used.

In particular, a VCSEL is a type of semiconductor laser with a structure that emits light vertically. This differs from the existing edge-emitting lasers, with a structure in which an active layer is located between two reflective mirrors (Bragg reflectors). This structure is composed of a very thin layer, and light is emitted in a vertical direction.

Light from the light source 121 may be directed through the diverging lens assembly toward the target object 101. The diverging lens assembly may include a first diverging lens 122 and a second diverging lens 123.

The first diverging lens 122 may collect light from the light source 121 and direct the light to the second diverging lens 123. Specifically, the first diverging lens 122 may serve to parallelize the light. This prevents the light from spreading widely in a specific direction and allows aiming parallel to a predetermined direction. The first diverging lens 122 may be composed of a convex lens or a composite optical system. Meanwhile, when the diverging light emitted from the light source 121 is passed through the first diverging lens 122, the first diverging lens 122 may adjust the light to be parallel, thereby directing the light from a point light source in parallel to a relatively long distance. This minimizes the spread of light and maintains the directionality of light, providing high precision and efficiency. For example, the first diverging lens 122 may include a collimator lens (CL), etc.

The second diverging lens 123 may utilize diffraction of light to form a specific pattern or beam. In particular, the second diverging lens 123 may perform various functions by manipulating the phase, amplitude, wavelength, etc. of light.

Specifically, the second diverging lens 123 may have a surface patterned with a microscopic structure, thereby being designed to diffract light in a particular way as light passes therethrough. This structure may typically be fabricated using techniques such as photolithography, nanoimprint lithography, and others.

When light passes through the surface pattern of the second diverging lens 123, the phase or amplitude of the light is changed to generate a desired diffraction pattern. For example, the second diverging lens 123 may split light into multiple light spots or form a specific image. Thus, the second diverging lens 123 may be capable of very precise beam shaping and manipulation and may perform more complex optical functions than traditional lenses and mirrors. For example, the second outgoing lens portion can include a diffuser, a diffractive optical element (DOE), a micro lens array (MLA), a Fresnel lens, and the like, and may include a lens or a prism that can change an optical path or an angle of emission of light.

The first diverging lens 122 and the second diverging lens 123 may be fixed onto the substrate 110 through the holder 140. At this point, the light source 121, the first diverging lens 122, and the second diverging lens 123 may be assembled to match each focal length, and may be fixed on the substrate 110 through the holder 140 with the focal length set.

In the light receiving operation S220, the light reflected from the target object 101 may be received by the converging lens assembly, and the light may be detected by the sensor unit 133.

The converging lens assembly 131 may receive light directed from a light source 121 and reflected from a target object 101 and direct the light to the sensor unit 133. The converging lens assembly 131 may collect light reflected and spread by the target object 101 so as to effectively deliver the light to the sensor unit 133.

Specifically, the converging lens assembly 131 may be a composite optical system composed of one or more lenses. This converging lens assembly 131 may utilize a convex lens to collect reflected light and may serve to focus the collected light. The converging lens assembly 131 refracts the reflected light passing through and directs the light onto a focal plane where the sensor unit 133 is located. This allows more reflected light to be directed to the sensor unit 133, thereby improving a signal-to-noise ratio (SNR) and increasing measurement accuracy. Using the converging lens assembly 131, light collection efficiency may be enhanced and the resolution of the optical system may be improved.

The filter 132 may serve to allow only light at a specific wavelength to pass therethrough and block other wavelengths. This is to reduce the influence of unnecessary external light sources and increase the accuracy of measurement.

Specifically, the filter 132 may be composed of a broadband filter or a narrowband filter, which are optical devices designed to selectively allow only light at a specific wavelength to pass therethrough.

Light emitted from the light source 121 has a specific wavelength, and when reflected light passes through the filter 132, the filter 132 allows only light at the specific wavelength to pass therethrough and blocks light at other wavelengths. For example, when using infrared light with a wavelength of 850 nm, the filter 132 allows only light at this wavelength to pass therethrough and blocks light at other wavelengths (e.g., visible light). This may reduce unnecessary light interference occurring in the surrounding environment, thereby increasing the purity of a signal transmitted to the sensor unit 133 and improving the accuracy and reliability of measurement.

The sensor unit 133 detects reflected light and converts the detected light into an electrical signal. The sensor unit 133 is one of the core components of a light source module 100 and may analyze and process received light data.

Specifically, when the reflected light reaches the sensor unit 133, one or more pixels included in the sensor unit 133 detect the light and convert the detected light into an electrical signal. In the case of a TOF system, the sensor unit 133 may calculate distance information by very accurately measuring a time at which light arrives.

The sensor unit 133 provides very high sensitivity and fast response time. This may enable high-accuracy 3D distance measurement and image processing.

The sensor unit 133 may be an image sensor, for example, a photodiode (PD), a charge-coupled device (CCD), a complementary metal-oxide semiconductor (CMOS), etc. In addition, an optical sensor 80 may be a device capable of sensing light, such as a photodetector (PD).

The sensor unit 133 may include a first sensor including one or more pixels for detecting light and capable of detecting light reflected from a target object, and a second sensor capable of detecting light directed from the optical path 152.

Here, the first sensor may be placed on the side of the light receiver 130 with respect to the light shielding structure 151, and the second sensor may be placed on the side of the light transmitter 120 with respect to the light shielding structure 151.

In the light emission recognizing operation S230, a portion of the light emitted from the light source 121 may be directed to one side of the sensor unit 133 through the optical path 152 to recognize a timing when light is emitted from the light source 121.

The optical path 152 may be provided between the light shielding structure 151 and the light transmitter 120 to form a light travel path through which light may travel from a light source 121 to a second sensor of the sensor unit 133.

Specifically, referring to the operation process of the light source module 100 of FIG. 5, light A is transmitted from the light source 121 placed on one side of the substrate 110, and the light A may pass through the first diverging lens 122 and the second diverging lens 123 and be directed toward the target object 101.

The light receiver 130 may receive light B reflected from the target object 101 and transmit the light B to the sensor unit 133 through the light receiver lens assembly 131 and the filter 132. Specifically, the light B may be directed to the first sensor of the sensor unit 133.

Meanwhile, some of the light C generated from the light source 121 may be directed to the second sensor through the optical path 152 to recognize a timing when light is emitted from the light source 121. This ensures accurate synchronization without any time delay.

Referring to FIGS. 8 to 15, an optical path 152 of various shapes to recognize and synchronize a timing when light is emitted may be observed.

Specifically, referring to FIGS. 8 and 9, the optical path 152 may be formed by penetrating a part of the optical path space structure 153. Therefore, the shape of the holder 140 may be maintained, and a part of the optical path space structure 153 may be penetrated to establish a connection with the light transmitter 120, thereby forming the optical path 152. In this case, light C generated from a light source 121 may pass through the optical path 152 formed at a location relatively close to a substrate 110 and move to the second sensor of the sensor unit 133.

Referring to FIGS. 10 and 11, the optical path 152 may be formed by penetrating a part of a lower side of the holder 140. Accordingly, the shape of the light shielding structure 151 may be maintained, and a part of the lower side of the holder 140 close to the substrate 110 may be penetrated to form the optical path 152. In this case, the light C generated from the light source 121 may pass through the optical path 152 formed at a relatively distant location from the substrate 110 and move to the second sensor of the sensor unit 133.

In this way, by adjusting a height at which the optical path 152 is formed, the amount of light C generated from the light source 121 may be controlled, thereby achieving more accurate synchronization.

Next, referring to FIGS. 12 and 13, the optical path 152 may further include a composition capable of controlling a light transmittance or light absorption rate. Therefore, the shapes of both the light shielding structure 151 and the holder 140 may be maintained. In this case, the amount of light C generated from the light source 121 may be controlled by the composition filled in the optical path 152.

Meanwhile, the composition included in the optical path 152 may be any material capable of controlling at least one of the light transmittance rate and light absorption rate of light C generated from the light source 121.

In addition, referring to FIGS. 14 and 15, the optical path 152 may include a plurality of protrusions extending inward within a path through which light travels. In this case, the plurality of protrusions formed inside the optical path 152 may vary in at least one of shape, spacing, and height to control an amount of light.

Specifically, when the amount of light C generated by the light source 121 is large, the spacing between the protrusions inside the optical path 152 may be configured to be narrower and the height may be increased, allowing for greater internal diffuse reflection of light C passing through the optical path 152. Conversely, when the amount of light C generated by the light source 121 is low, the spacing between the protrusions inside the optical path 152 may be configured to be wider and the height may be reduced, allowing for less internal diffuse reflection of light C passing through the optical path 152.

Furthermore, a coating layer may be formed by additionally applying a coating agent capable of controlling a light transmittance or light absorption rate to the surfaces of the plurality of protrusions. The coating layer may further adjust the amount of light C passing through the light passage portion 152, etc.

As such, by adjusting the internal composition or geometry of the optical path 152 to control the amount of light C generated by the light source 121, more accurate synchronization may be achieved.

Here, the light emitting operation S210 and the light emission recognizing operation S230 are performed simultaneously so that accurate synchronization may be achieved.

In addition, since terms, such as “including,” “comprising,” and “having” mean that one or more corresponding components may exist unless they are specifically described to the contrary, it shall be construed that one or more other components can be further included. All of the terminologies including one or more technical or scientific terminologies have the same meanings that those having ordinary knowledge in the technical field of the present disclosure understand ordinarily unless they are defined otherwise. A term ordinarily used like that defined by a dictionary shall be construed that it has a meaning equal to that in the context of a related description, and shall not be construed in an ideal or excessively formal meaning unless it is clearly defined in the present specification.

Although exemplary embodiments of the present disclosure have been described for illustrative purposes, those having ordinary knowledge in the technical field of the present disclosure will appreciate that various modifications, additions and substitutions are possible, without departing from the scope and spirit of the present disclosure as disclosed in the accompanying claims. Therefore, the embodiments disclosed in the present disclosure are intended to illustrate the scope of the technical idea of the present disclosure, and the scope of the technical idea of the present disclosure is not limited by the embodiments. The protection scope of the present disclosure should be construed based on the accompanying claims, and it should be construed that all of the technical ideas included within the scope equivalent to the claims are included within the right scope of the present disclosure.

What is claimed is:

1. A light source module comprising:
a light transmitter comprising a light source placed on one side of a substrate and emitting light for measuring a depth distance, and a diverging lens assembly emitting light directed from the light source toward a target object;
a light receiver comprising a converging lens assembly for receiving the light reflected from the target object, and a sensor unit comprising a single pixel or multiple pixels for detecting the light;
a holder for fixing the light transmitter and the light receiver onto the substrate; and
a connection unit comprising a light shielding structure for blocking noise light directly coming from the light source of the light transmitter to the light receiver, an optical path provided between the light shielding structure and the light transmitter to recognize a timing when the light is emitted from the light source, and an optical path space structure located below the optical path.

2. The light source module of claim 1, wherein the diverging lens assembly comprises a first diverging lens for collecting the light directed from the light source and a second diverging lens for emitting the collected light toward the target object.

3. The light source module of claim 2, wherein the holder fixes the first diverging lens and the second diverging lens onto the substrate.

4. The light source module of claim 1, wherein the light receiver further comprises a filter that allows only a wavelength of light detectable by the sensor unit to pass therethrough.

5. The light source module of claim 1, wherein the sensor unit comprises a first sensor capable of detecting the light reflected from the target object and a second sensor capable of detecting the light directed from the optical path.

6. The light source module of claim 5, wherein:
the first sensor is positioned on a side of the light receiver unit with respect to the light shielding structure, and
the second sensor is positioned on a side of the light transmitter with respect to the light shielding structure.

7. The light source module of claim 1, wherein:
the light shielding structure is placed on the sensor unit and has a shape protruding from the sensor unit, and
a height of one end of the light shielding structure is higher than a height of one end of the light source.

8. The light source module of claim 1, wherein, by being placed between the sensor unit and the holder to form a hermetically sealed connection, the light shielding structure blocks light directly coming from the light transmitter.

9. The light source module of claim 1, wherein the light shielding structure and the optical path space structure are placed as a single integrally connected structure or placed separately as distinct structures.

10. The light source module of claim 1, wherein the optical path is formed by penetrating a part of the optical path space structure.

11. The light source module of claim 1, wherein the optical path is formed by penetrating a part of a lower side of the holder.

12. The light source module of claim 1, wherein the optical path further comprises a composition capable of controlling a light transmittance or light absorption rate.

13. The light source module of claim 1, wherein the optical path comprises a plurality of protrusions extending inward within a path through which light travels, allowing for control over an amount of light.

14. The light source module of claim 13, wherein:
the plurality of protrusions vary in at least one of shape, spacing, and height, and
each of the plurality of protrusions comprises a coating layer formed in a surface thereof, which controls a light transmittance or light absorption rate.

15. A method for operating a light source module, the method comprising:
a light emitting operation in which a light source emits light for measuring a depth distance from a light source and a diverging lens assembly emits light toward a target object;
a light receiving operation in which a converging lens assembly receives the light reflected from the target object and a sensor unit detects the light; and
a light emission recognizing operation in which a part of the light emitted from the light source is directed to one side of the sensor unit through an optical path to recognize a timing when light is emitted from the light source,
wherein the light emitting operation and the light emission recognizing operation are performed simultaneously.

16. The method of claim 15, wherein the sensor unit comprises a first sensor capable of detecting the light reflected from the target object and a second sensor capable of detecting light directed from the optical path.

17. The method of claim 15, wherein the optical path is formed by penetrating a part of the optical path space structure.

18. The method of claim 15, wherein the optical path is formed by penetrating a part of a lower side of the holder.

19. The method of claim 15, wherein the optical path further comprises a composition capable of controlling a light transmittance or light absorption rate.

20. The method of claim 15, wherein:
the optical path comprises a plurality of protrusions extending inward within a path through which light travels, allowing for control over an amount of light,
the plurality of protrusions vary in at least one of shape, spacing, and height, and each of the plurality of protrusions comprises a coating layer formed in a surface thereof, which controls a light transmittance or light absorption rate.
